(19) United States
(12) Patent Application Publication
(10) Pub. No.: US 2020/0368795 A1
(43) Pub. Date: Nov. 26, 2020

(54) PRODUCTION JIG CLEANING MANAGEMENT DEVICE, METHOD, AND NON-TRANSITORY STORAGE MEDIUM IMPLEMENTING METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XUE-FENG CHE, Shenzhen (CN); JUN LI, Yantai (CN); NIAN WAN, Yantai (CN)

(21) Appl. No.: 16/574,496

(22) Filed: Sep. 18, 2019

(30) Foreign Application Priority Data
May 20, 2019 (CN) 201910418572.4

(51) Int. Cl. B08B 13/00; G05B 19/042

(52) U.S. Cl. CPC B08B 13/00; G05B 2219/2642; G05B 2219/2633; G05B 19/042

(57) ABSTRACT

A production jig cleaning management device coupled to a transport robot, a washing machine, a dryer, and a detection device includes a processor and a memory. The processor acquires identification information of a production jig, determines whether the production jig meets a preset cleanliness standard, controls the transport robot to store the production jig when the production jig meets the preset cleanliness standard, and controls the washing machine and the dryer to perform cleaning and drying operations on the production jig when the production jig does not meet the preset cleanliness standard. The processor re-examines the washed and dried production jig to determine whether the production jig meets the preset cleanliness standard.

### FIELD

The subject matter herein generally relates to production jigs, and more particularly to a production jig cleaning management device, method, and non-transitory storage medium implementing the method.

### BACKGROUND

Generally, most manufacturers do not systematically clean and manage production jigs, such as steel mesh, scrapers, and other fixtures used in production, and cleaning conditions of the production jigs cannot be effectively monitored. Thus, there is a risk of uncleaned production jigs reducing product yield.

### BRIEF DESCRIPTION OF THE DRAWINGS

Implementations of the present disclosure will now be described, by way of embodiments, with reference to the attached figures.

FIG. 1 is a schematic block diagram of an embodiment of a production jig cleaning management device coupled to a transport robot, a washing machine, a dryer, and a detection device according to one embodiment of the present disclosure.

FIG. 2 is a schematic block diagram of functional modules of a production jig cleaning management system stored in the production jig cleaning management device according to one embodiment of the present disclosure.

FIG. 3 is a flowchart of a production jig cleaning management method according to one embodiment of the present disclosure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

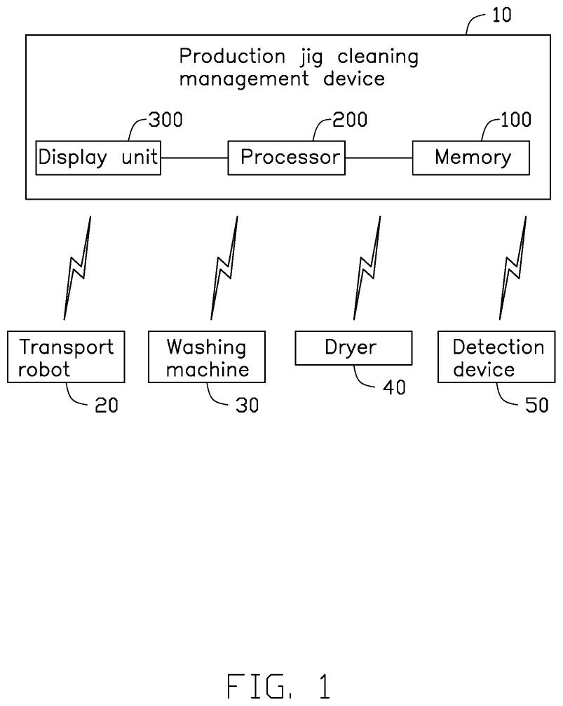

FIG. 1 shows an embodiment of a production jig cleaning management device 10 communicably coupled to a transport robot 20, a washing machine 30, a dryer 40, and a detection device 50. The production jig cleaning management device 10 includes a memory 100, a processor 200, and a display unit 300. The memory 100 and the display unit 300 are electrically coupled to the processor 200.

The memory 100 stores various types of data, such as program codes of the production jig cleaning management device 10 for cleaning, drying, and detection, which are executed by the processor 200.

The memory 100 can be, but is not limited to, a Read-Only Memory (ROM), a Random Access Memory (RAM), a Programmable Read-Only Memory (PROM), an Erasable Programmable Read-Only Memory (EPROM), a One-Time Programmable Read-Only Memory (OTPROM), an Electrically-Erasable Programmable Read-Only Memory (EEPROM), a Compact Disc Read-Only Memory (CD-ROM), or other optical disk storage, disk storage, magnetic tape storage, or any other medium readable by a computer that can be used to carry or store data.

The processor 200 processes related data in the memory 100.

The processor 200 may be a central processing unit (CPU), a digital signal processor, a single chip microcomputer, or the like.

The display unit 300 displays relevant data results processed by the processor 200.

The display unit 300 may be, but is not limited to, a touch display screen or a liquid crystal display.

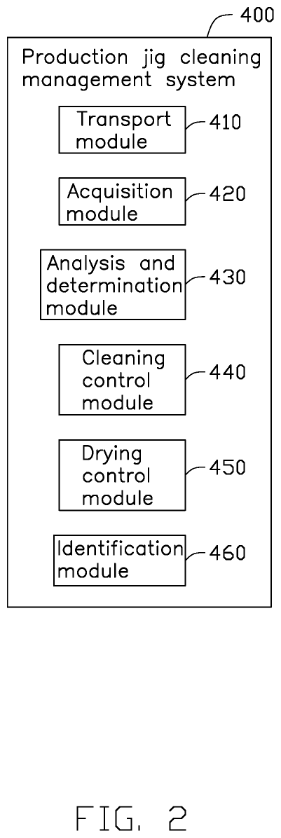

Referring to FIG. 2, the production jig cleaning management device 10 runs a production jig cleaning management system 400. The production jig cleaning management system 400 includes computer instructions in the form of one or more programs being stored in the memory 100 and executed by the processor 200.

In one embodiment, the production jig cleaning management system 400 includes a transport module 410, an acquisition module 420, an analysis and determination module 430, a cleaning control module 440, a drying control module 450, and an identification module 460.

The transport module 410 controls the transport robot 20 to transport a production jig.

Specifically, the transport module 410 can control the transport robot 20 to transport the production jig placed in an entrance area, an information collection area, a cleaning area, a drying area, a storage area, and an exit area according to program instructions.

The entrance area is used for placing production jigs from a production line, production jigs damaged in the production line, and production jigs that have just been produced and processed. The information collection area is used for placing production jigs for information collection. The cleaning area is used for placing production jigs for cleaning. The drying area is used for placing production jigs for drying. The storage area is used for storing production jigs that have been cleaned. The exit area is used for placing production jigs that are ready for use.

The acquisition module 420 collects identification information and status information of the production jig.

Specifically, the transport module 410 controls the transport robot 20 to carry the production jig placed in the entrance area to the information collection area, and the acquisition module 420 collects the identification information and status information of the production jig transported to the information collection area.

The identification information includes, but is not limited to, a serial number, a letter, a number, a symbol, a two-dimensional code, and a one-dimensional code.

Status information includes, but is not limited to, information of surface cleanliness and damage of the production jig.

In one embodiment, the acquisition module 420 collects the above information through an information collection device, such as a surface scanner, a code scanner, or the like.

In one embodiment, the analysis and determination module 430 detects and determines whether the production jig meets a preset cleanliness standard according to the acquired information.

Specifically, after acquiring the information, the transport robot 20 transports the production jig to a detection area, and the analysis and determination module 430 controls the detection device 50 to analyze the production jig in the detection area and determine whether the production jig meets the preset cleanliness standard. If the production jig meets the preset cleanliness standard, the transport module 410 controls the transport robot 20 to transport the production jig to the storage area for storage. If the production jig does not reach the preset cleanliness standard, the transport module 410 controls the transport robot 20 to transport the production jig to the cleaning area where cleaning operations are performed on the production jig.

The analysis and determination module 430 determines whether the production jig meets the preset cleanliness standard by comparing a surface image of the dried production jig to a preset image, and determining whether a comparison result is less than a similarity threshold. The surface image is obtained from the detection device 50. The similarity threshold is obtained based on a surface condition of the production jig after cleaning and drying, such as a number of stains and a size of the stain.

It can be understood that, in one embodiment, after determining that the production jig meets the preset cleanliness standard, the analysis and determination module 430 further detects a degree of damage of the production jig, a number of uses, and a product yield of the production jig. When one or more of the degree of damage, the number of uses, and the product yield do not meet a certain value, the production jig can be manually examined by an operator for determination.

The product yield refers to a ratio between a quantity of products manufactured by the production jig reaching a preset standard and a total quantity of products manufactured by the production jig.

The certain value may be specifically set according to different scenarios and different production jigs.

The cleaning control module 440 controls the washing machine 30 to perform cleaning operations for cleaning the production jig.

Specifically, the transport module 410 controls the transport robot 20 to transport the production jig that does not reach the preset cleanliness standard to the cleaning area, and the cleaning control module 440 controls the washing machine 30 to clean the production jig in the cleaning area.

The drying control module 450 controls the dryer 40 to perform drying operations on the cleaned production jig.

Specifically, the transport module 410 controls the transport robot 20 to transport the cleaned production jig to the drying area, and the drying control module 450 controls the dryer 40 to perform drying operations on the production jig in the drying area.

The identification module 460 selects a production jig in the storage area that matches a product for production.

Specifically, the identification module 460 automatically selects a corresponding production jig in the storage area according to externally input identification information. The transport module 410 controls the transport robot 20 to transport the production jig selected by the identification module 460 according to the externally input identification information to the exit area.

In one embodiment, when the production jig corresponding to the externally input identification information is damaged, the status information of the damaged production jig is displayed on the display unit 300.

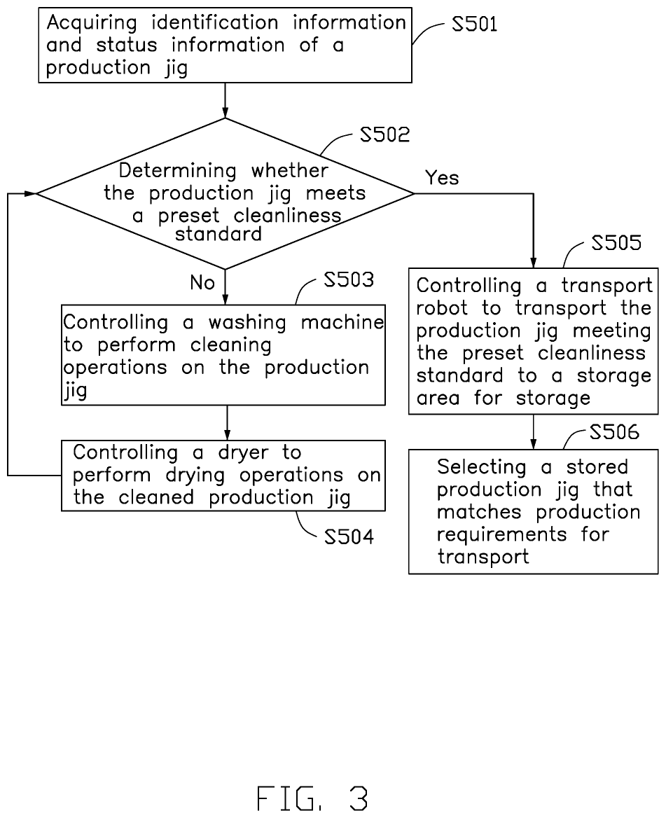

FIG. 3 shows a flowchart of a production jig cleaning management method. The method is provided by way of embodiment, as there are a variety of ways to carry out the method. The method described below can be carried out using the configurations illustrated in FIGS. 1-2, for example, and various elements of these figures are referenced in explaining the example method. Each block shown in FIG. 3 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure.

At block S501, the identification information and status information of the production jig are acquired.

The transport module 410 controls the transport robot 20 to transport the production jig placed in the entrance area to the information collection area. The entrance area is used for placing production jigs from a production line, production jigs damaged in the production line, and production jigs that have just been produced and processed. The information collection area is used for placing production jigs for information collection. The acquisition module 420 collects the identification information and status information of the production jig in the information collection area.

The identification information includes, but is not limited to, a serial number, a letter, a number, a symbol, a two-dimensional code, and a one-dimensional code.

Status information includes, but is not limited to, information of surface cleanliness and damage of the production jig.

In one embodiment, the acquisition module 420 collects the above information through an information collection device, such as a surface scanner, a code scanner, or the like.

At block S502, whether the production jig meets the preset cleanliness standard is determined.

Specifically, the transport robot 20 transports the production jig to the detection area, and the analysis and determination module 430 controls the detection device 50 to analyze the production jig and determine whether the production jig meets the preset cleanliness standard. If the production jig meets the preset cleanliness standard, block S505 is implemented. If the production jig does not meet the preset cleanliness standard, block S503 is implemented.

The analysis and determination module 430 determines whether the production jig meets the preset cleanliness standard by comparing a surface image of the dried production jig to a preset image, and determining whether a comparison result is less than a similarity threshold. The surface image is obtained from the detection device 50. The similarity threshold is obtained based on a surface condition of the production jig after cleaning and drying, such as a number of stains and a size of the stain.

It can be understood that, in one embodiment, after determining that the production jig meets the preset cleanliness standard, the analysis and determination module 430 further detects a degree of damage of the production jig, a number of uses, and a product yield of the production jig. When one or more of the degree of damage, the number of uses, and the product yield do not meet a certain value, the production jig can be inspected by an operator for determination.

The product yield refers to a ratio between a quantity of products manufactured by the production jig reaching a preset standard and a total quantity of products manufactured by the production jig.

The certain value may be specifically set according to different scenarios and different production jigs.

At block S503, the washing machine 30 is controlled to perform cleaning operations on the production jig.

Specifically, the transport module 410 controls the transport robot 20 to transport the production jig not meeting the preset cleanliness standard to the cleaning area, and the cleaning control module 440 controls the washing machine 30 to perform the cleaning operations on the production jig in the cleaning area.

At block S504, the dryer 40 is controlled to perform drying operations on the cleaned production jig.

Specifically, the transport module 410 controls the transport robot 20 to transport the cleaned production jig to the drying area, and the drying control module 450 controls the dryer 40 to perform the drying operations on the production jig in the drying area. After the production jig is cleaned and dried, block S502 may be implemented to re-determine whether the production jig meets the preset cleanliness standard.

At block S505, the transport module 410 controls the transport robot 20 to transport the production jig meeting the preset cleanliness standard to the storage area for storage.

At block S506, the stored production jig that matches production requirements is selected for transport.

Specifically, the identification module 460 automatically selects a corresponding production jig in the storage area according to externally input identification information. The transport module 410 controls the transport robot 20 to transport the production jig selected by the identification module 460 according to the externally input identification information to the exit area.

In one embodiment, when the production jig corresponding to the externally input identification information is damaged, the status information of the damaged production jig is displayed on the display unit 300.

The production jig cleaning management device 10 and method provided by the present disclosure acquires basic information of the production jig and determines whether the production jig meets the preset cleanliness standard. When the preset cleanliness standard is met, the production jig is stored. When the preset cleanliness standard is not met, the production jig is washed and dried, and then re-examined to determine whether the production jig meets the preset cleanliness standard. Thus, a service life of the production jig is greatly prolonged, and efficiency of cleaning and management of the production jig is improved.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A production jig cleaning management method comprising:
acquiring identification information of a production jig;
determining whether the production jig meets a preset cleanliness standard;
storing the production jig if the production jig meets the preset cleanliness standard; and
performing cleaning and drying operations on the production jig, if the production jig does not meet the preset cleanliness standard, and re-examining the production jig and determining whether the production jig meets the preset cleanliness standard.

2. The production jig cleaning management method of claim 1, further comprising:
acquiring status information of the production jig when the identification information of the production jig is acquired; wherein:
the identification information comprises at least one selected from the group of a serial number, a letter, a number, a symbol, a two-dimensional code, and a one-dimensional code; and
the status information comprises information of surface cleanliness and damage of the production jig.

3. The production jig cleaning management method of claim 1, wherein the step of determining whether the production jig meets the preset cleanliness standard comprises:
acquiring a surface image of the production jig;
comparing the surface image to a preset image; and
determining whether a comparison result between the surface image and the preset image is less than a similarity threshold.

4. The production jig cleaning management method of claim 1, wherein the method further comprises selecting and transporting the production jig in a storage area that matches a product requirement after the step of storing the production jig if the production jig meets the preset cleanliness standard.

5. The production jig cleaning management method of claim 1, further comprising;
detecting, if the production jig meets the preset cleanliness standard, a degree of damage, a number of uses, and a product yield of the production jig; wherein
when one or more of the degree of damage, the number of uses, and the product yield do not meet a certain value, the production jig is manually examined for determination.

6. A production jig cleaning management device coupled to a transport robot, a washing machine, a dryer, and a detection device, the production jig cleaning management device comprising:
a processor; and
a memory storing a plurality of instructions, which when executed by the processor, cause the processor to:
acquire identification information of a production jig;
determine whether the production jig meets a preset cleanliness standard;
control the transport robot to store the production jig if the production jig meets the preset cleanliness standard; and
control the washing machine and the dryer to perform cleaning and drying operations on the production jig, if the production jig does not meet the preset cleanliness standard, and re-examine the production jig and determine whether the production jig meets the preset cleanliness standard.

7. The production jig cleaning management device of claim 6, wherein the processor is further caused to acquire status information of the production jig when the identification information of the production jig is acquired; wherein:
the identification information comprises at least one selected from the group of a serial number, a letter, a number, a symbol, a two-dimensional code, and a one-dimensional code; and
the status information comprises information of surface cleanliness and damage of the production jig.

8. The production jig cleaning management device of claim 6, wherein the processor determines whether the production jig meets the preset cleanliness standard by:
acquiring a surface image of the production jig;
comparing the surface image to a preset image; and
determining whether a comparison result between the surface image and the preset image is less than a similarity threshold.

9. The production jig cleaning management device of claim 6, wherein the processor is further caused to:
select and transport the production jig in a storage area that matches a product requirement.

10. The production jig cleaning management device of claim 1, wherein the processor is further caused to:
detect, after the production jig meets the preset cleanliness standard, a degree of damage, a number of uses, and a product yield of the production jig.

11. A non-transitory storage medium having stored thereon instructions that, when executed by a processor of a production jig cleaning management device, causes the processor to execute instructions of a production jig cleaning management method, the method comprising:
acquiring identification information of a production jig;
determining whether the production jig meets a preset cleanliness standard;
storing the production jig if the production jig meets the preset cleanliness standard; and
performing cleaning and drying operations on the production jig, if the production jig does not meet the preset cleanliness standard, and re-examining the production jig and determining whether the production jig meets the preset cleanliness standard.

12. The non-transitory storage medium of claim 11, wherein the method further comprises:
acquiring status information of the production jig when the identification information of the production jig is acquired; wherein:
the identification information comprises at least one selected from the group of a serial number, a letter, a number, a symbol, a two-dimensional code, and a one-dimensional code; and
the status information comprises information of surface cleanliness and damage of the production jig.

13. The non-transitory storage medium of claim 11, wherein the step of determining whether the production jig meets the preset cleanliness standard comprises:
acquiring a surface image of the production jig;
comparing the surface image to a preset image; and
determining whether a comparison result between the surface image and the preset image is less than a similarity threshold.

14. The non-transitory storage medium of claim 11, the method further comprising:
selecting and transporting the production jig in a storage area that matches a product requirement.

15. The non-transitory storage medium of claim 11, the method further comprising:
detecting, if the production jig meets the preset cleanliness standard, a degree of damage, a number of uses, and a product yield of the production jig; wherein:
when one or more of the degree of damage, the number of uses, and the product yield do not meet a certain value, the production jig is manually examined for determination.
